(19) United States
(12) Patent Application Publication
(10) Pub. No.: US 2018/0048883 A1
(43) Pub. Date: Feb. 15, 2018

(54) IMAGE DISPLAY APPARATUS AND IMAGE DISPLAY METHOD

(71) Applicant: CHERAY CO. LTD., HSINCHU CITY (TW)

(72) Inventors: CHUN-HSIANG YANG, HSINCHU CITY (TW); YI-PAI HUANG, HSINCHU CITY (TW); JUI-YI WU, MIAOLI COUNTY (TW); CHI-KUANG LAI, TAOYUAN CITY (TW); CHIH-HUNG TING, NEW TAIPEI CITY (TW)

(21) Appl. No.: 15/658,059

(22) Filed: Jul. 24, 2017

(30) Foreign Application Priority Data
Aug. 10, 2016 (TW) 105125432

(51) Int. Cl. H04N 13/04; G02B 27/22

(52) U.S. Cl. CPC H04N 13/0404; H04N 13/0484; G02B 27/2292; G02B 27/2214; G02B 3/0056

(57) ABSTRACT

An image display apparatus that displays a stereo image floating in mid-air and is able to be observed at an oblique angle of view. The image display apparatus includes an image display device, which includes a display surface and an image calculating unit. The image display device is configured to display an un-reconstruction image on the display surface by the image calculating unit. A lens array layer is disposed on the display surface of the image display device. The lens array layer includes a base and a plurality of lenses. The lenses are disposed on a surface of the base. The lens array layer is configured to reconstruct the un-reconstruction image on the display surface as an integrated image so as to reproduce a stereo image.

### BACKGROUND OF THE INVENTION

### Field of the Invention

The present disclosure relates to an image display apparatus and an image display method; in particularly to, an image display apparatus using the naked-eye 3D technology which is of a simple structure and user-friendly.

### Description of Related Art

Generally, conventional three dimensional image display devices mainly employ the binocular vision fusion imaging technology. Regarding to these kinds of image display devices, the user has to view the stereo image at a straight angle of view, or the image depth cannot be too far away from a display surface of the display device. When three dimensional image display using in such as aviation terrain models, building models, and 3D medical training devices, the all device is placed horizontally, but the oblique angle of view is natural to the user. However, conventional three dimensional image display devices are incapable of providing a natural angle of view, thus inconveniencing to the user. Moreover, conventional three dimensional image display devices provide the user with visual stimuli in only one direction, i.e., either with the image advancing forward, or withdrawing backward. Therefore, conventional three dimensional image display devices cannot provide a vivid sensation that the image is escaping the confines of the plane of the display surface and floating in mid-air.

In this regard, the present disclosure provides an image display apparatus and an image display method to overcome the aforementioned drawbacks.

### SUMMARY OF THE INVENTION

The present disclosure provides an image display apparatus and an image display method for displaying a floating stereo image and allowing an oblique angle of view natural to the user when the image display apparatus is placed horizontally.

To resolve the above technical problems, the present disclosure provides an image display apparatus that displays a stereo image floating in mid-air and is able to be observed at an oblique angle of view. The image display apparatus includes an image display device, which includes a display surface and an image calculating unit. The image display device is configured to display an un-reconstruction image on the display surface by the image calculating unit. A lens array layer is disposed on the display surface of the image display device. The lens array layer includes a base and a plurality of lenses. The lenses are disposed on a surface of the base, and each of the lenses transmits light having a wavelength range of 300 nm to 1100 nm. The lens array layer is configured to reconstruct the un-reconstruction image on the display surface as an integrated image so as to reproduce a stereo image.

The present disclosure also provides an image display method which includes: providing an image display apparatus, the image display apparatus including an image display device and a lens array layer, the image display device including a display surface and an image calculating unit, the lens array layer being disposed on the display surface of the image display device, the lens array layer including a base and a plurality of lenses, the lenses being disposed on a surface of the base, and each of the lenses transmits light having a wavelength range of 300 nm to 1100 nm; executing a coordinate definition step for setting relative positions of hardware, the relative positions of hardware including a relative position of each of the lenses of the lens array layer, a distance between the lens array layer and the image display device, and a pixel size match; inputting data of a three dimensional object prepared to display to the image calculating unit; setting a displaying oblique angle of the three dimensional object; performing a ray tracing operation and displaying an un-reconstruction image on the display surface of the image display device; and reconstructing the un-reconstruction image on the display surface as an integrated image through the lens array layer to reproduce a stereo image.

The present disclosure has at least the following advantages.

In terms of hardware, the image display apparatus of the present disclosure requires only an image display device and a lens array layer to achieve the floating stereo image without using other optical films, thereby providing a relative simple structure. The image display method of the present disclosure, which is different from the general integrated image calculation algorithms, can be applied to an oblique angle of view, and can provide the calculated image corresponding to a particular angle.

The main concept of the floating stereo image is allowing the user to receive the sensation of a vivid floating effect. The oblique angle of view in the image display method can be used to facilitate the user to confirm the corresponding depth and position of the image in the space so as to achieve the floating effect.

In order to further the understanding of the present disclosure, the following embodiments are provided along with illustrations to facilitate the disclosure of the present disclosure.

### BRIEF DESCRIPTION OF THE DRAWINGS

FIG. 1 is a perspective view of an image display apparatus according to a first embodiment of the present disclosure;

FIG. 2 is a planar view of the image display apparatus which provides a vertical angle of view to a user according to the first embodiment of the present disclosure;

FIG. 3 is a planar view of the image display apparatus which provides an oblique angle of view to the user according to the first embodiment of the present disclosure;

FIG. 4 is a planar view of the image display apparatus which provides another oblique angle of view to the user according to the first embodiment of the present disclosure;

FIG. 5 is a flow chart of an image display method according to a second embodiment of the present disclosure;

FIG. 6 is a schematic diagram of an image display apparatus controlled by an algorithm according to the second embodiment of the present disclosure;

FIG. 7 is a planar view of a lens array layer arranged in an aligned arrangement in the image display apparatus according to a third embodiment of the present disclosure;

FIG. 8 is a planar view of the lens array layer arranged in an staggered arrangement in the image display apparatus according to the third embodiment of the present disclosure;

FIG. 9 is a schematic view of a single lens which is focusing light in the image display apparatus according to the third embodiment of the present disclosure;

FIG. 10 is a schematic view showing a usage state of the image display apparatus according to a fourth embodiment of the present disclosure;

FIG. 11 is a perspective view of a lens array layer having columnar structure in the image display apparatus according to a fifth embodiment of the present disclosure; and

FIG. 12 is a schematic planar view of the lens array layer having columnar structure in the image display apparatus according to the fifth embodiment of the present disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In addition, for an easy instruction, similar reference numbers or symbols refer to elements alike.

### First Embodiment

The present disclosure provides an image display apparatus, which can be used in industries such as optoelectronics, medical, military, exhibition, display, education, entertainment, and consumer electronics. The image display apparatus can be used in active and passive three dimensional stereoscopic display apparatus, but is not limited thereto.

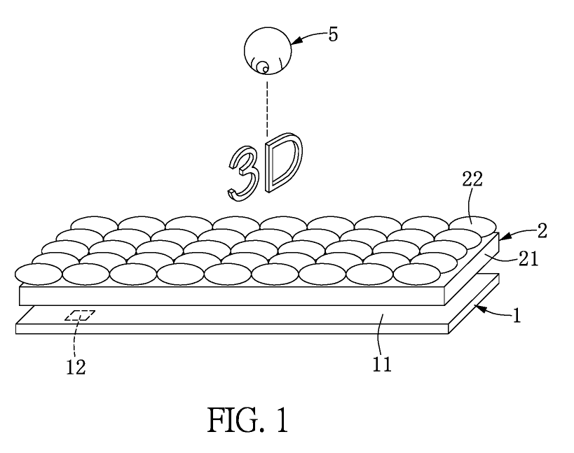

Referring to FIG. 1, the image display apparatus includes an image display device 1 and a lens array layer 2. The image display apparatus can alter a stereo image that the user sees by altering a displayed image, and allows the user to see the stereo image at different angles of view. The image display apparatus of the present disclosure is a two-layer structure, which can be placed on tables, walls, ceilings, or any planes.

The image display device 1 includes a display surface 11 for displaying an image. The lens array layer 2 is disposed on the display surface 11 of the image display device 1, in other words, the lens array layer 2 is disposed above the image display device 1. The lens array layer 2 can be arranged in contact with the display surface 11 of the image display device 1. The lens array layer 2 can be arranged spaced apart from the display surface 11 of the image display device 1. In addition, a spacer can be disposed between the display surface 11 of the image display device 1 and the lens array layer 2.

The image display device 1 is located at a first layer (i.e., a bottom layer) of the image display apparatus, and is configured to display an un-reconstruction planar image that has not been reproduced. The planar image can be reconstructed as an integrated image by the lens array of the lens array layer 2, so that a stereo image can be reproduced. Moreover, the image display device 1 disposed on the first layer is configured to display a target image. Therefore, the image display device 1 in the present disclosure can be any types of hardware including, but not limited to, a mobile phone, a tablet, a flat panel display, a printed image, an engraved image, or a projection display image.

The lens array layer 2 is located at a second layer (i.e., a top layer) of the image display apparatus, and has the ability to control the light field. The lens array layer 2 can be configured to control the angle of light of the three dimensional object, and can be configured to reconstruct the un-reconstruction planar image on the display surface 11, thereby allowing the user 5 to see a stereo image. The curvature of each lens 22 of the lens array layer 2 is determined by the material thereof. The curvatures of the lenses 22 of the lens array layer 2 as well as the combination of the lenses 22 and the image display device 1 located at the first layer determine the height, the range of angle of view, and the clarity of the stereo image.

In the present embodiment, the lens array layer 2 is made of a material with good optical characteristics, which includes, but is not limited to, polymethylmethacrylate (PMMA), polycarbonate (PC), polyethylene (PE), glass and other light-transmission materials. The lens array layer 2 includes a base 21 and a plurality of lenses 22. The lenses 22 are disposed on a surface of the base 21, in other words, the lenses 22 are disposed on a surface of the base 21 away from the image display device 1. Moreover, the lenses 22 have the ability to focus light. It should be noted that the arrangement and the structure of the lens array layer 2 are not limited to the present embodiment.

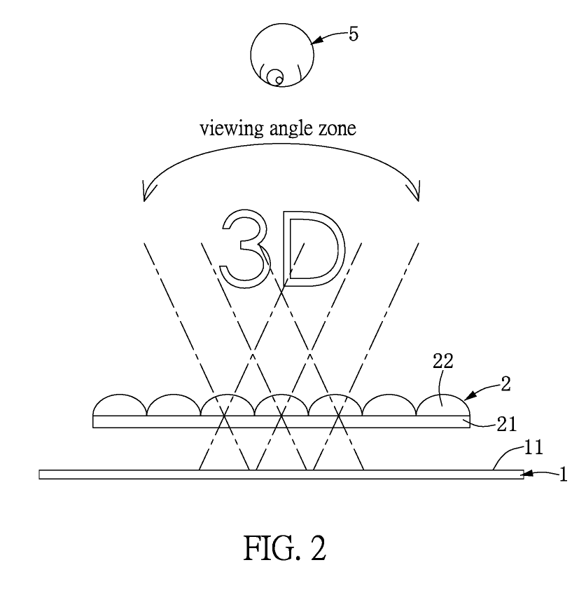

There exist drawbacks of angle of view in most of the conventional naked-eye three dimensional image display apparatuses so that the user 5 cannot see the stereo image at an oblique angle of view. The main feature of the present disclosure is that the user 5 can see the stereo image at an oblique angle of view, although the user 5 is not in front of the image display device 1. Referring to FIG. 2, when the user 5 is in front of the image display device 1 (i.e., zero order viewing zone), the image display device 1 has a limited viewing angle zone for the user 5. Once the user's sight is out of the viewing angle zone, the user 5 will not see the correct stereo image.

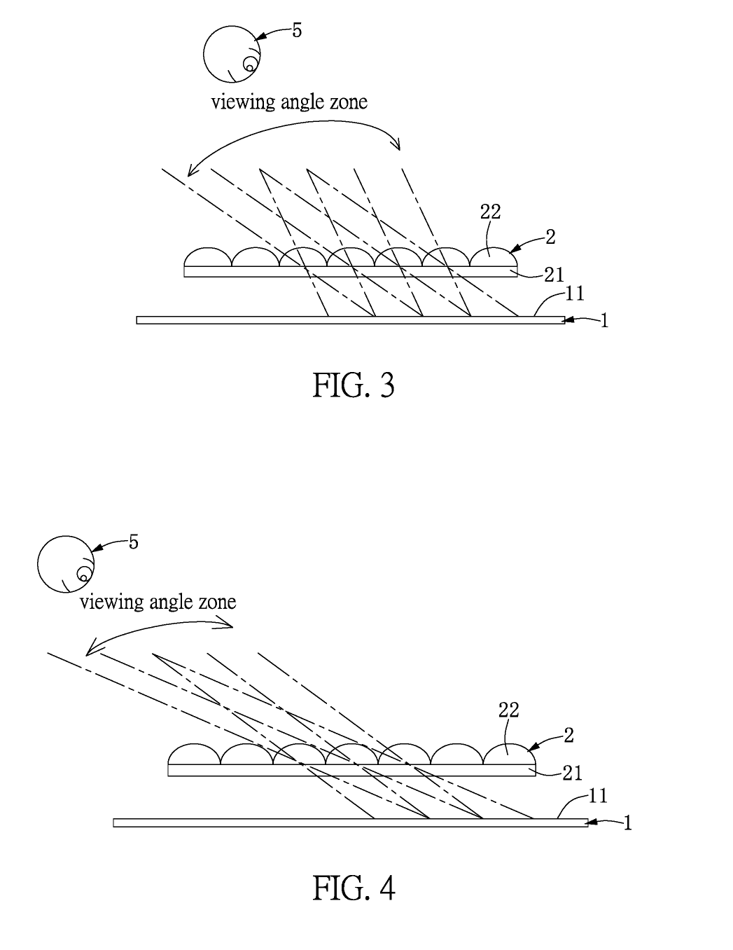

In order to allow the user 5 to see the stereo image at an oblique angle of view, the present embodiment employs the displaying method as shown in FIG. 3 and FIG. 4, using an oblique angle image display method instead of a zero order (forward) image display method. That is, the path of the lights will be converged in an oblique direction, so that the user 5 can see the stereo image at the oblique angle of view. FIG. 3 and FIG. 4 are the viewing zones, which are set to the first order viewing zone and the second order viewing zone respectively. That is, the larger the oblique angle of view is, the larger the order of the viewing zone is. Thus the viewing zone can be set to a third order viewing zone, a fourth order viewing zone, or a higher order viewing zone. At the same time, the un-reconstruction planar image also needs to be adjusted accordingly. The corresponding algorithm will be described in the second embodiment. With the image of the same order, the user 5 can see the stereo image at the corresponding oblique angle of view. The oblique angle image display method in the present disclosure can be applied to various special occasions. For example, when the image display device 1 needs to be hidden, or when the user 5 is viewing the stereo image at a non-vertical angle of view.

### Second Embodiment

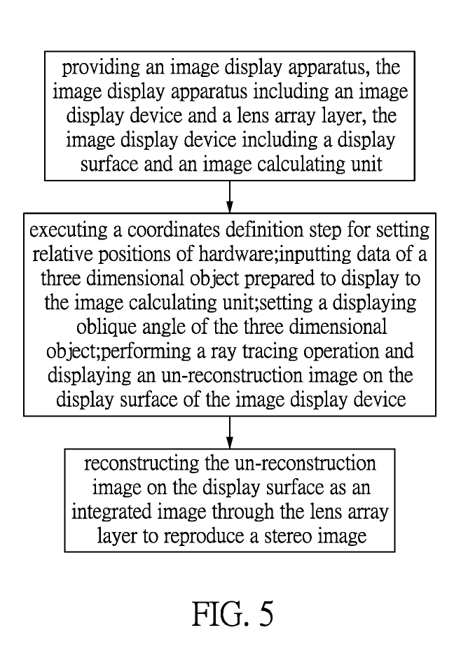

The image display device 1 in the present disclosure can be any specification as long as it can be applied to an image algorithm. In other words, the image display device 1 includes an image calculating unit 12 including an image algorithm. The image used in the image display device 1 is calculated by the image algorithm. This calculation is matched to the configuration of the lens array layer 2, which predicts the various possible paths of the light, thereby calculating the relative position of the image. FIG. 5 is a flowchart of an image display method of the present disclosure, which comprises the following steps.

Firstly, providing an image display apparatus. The image display apparatus includes an image display device 1 and a lens array layer 2 (as shown in FIG. 1). The image display device 1 includes a display surface 11 and an image calculating unit 12. The lens array layer 2 is disposed on the display surface 11 of the image display device 1. The lens array layer 2 includes a base 21 and a plurality of lenses 22. The lenses 22 are disposed on a surface of the base 21.

Secondly, executing a coordinate definition step for setting relative positions of hardware which includes a relative position of each of the lenses 22 of the lens array layer 2, a distance between the lens array layer 2 and the image display device 1, and a pixel size match; inputting data of a three dimensional object prepared to display to the image calculating unit 12; setting a displaying oblique angle of the three dimensional object; and performing a ray tracing operation and displaying an un-reconstruction image on the display surface 11 of the image display device 1.

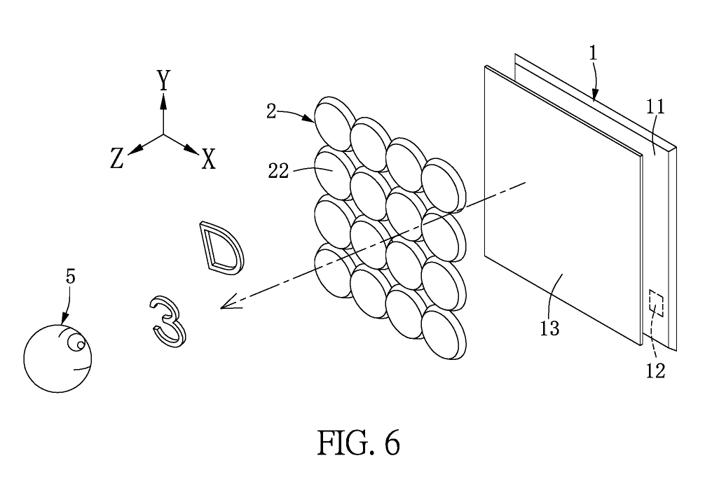

Finally, referring to FIG. 6, reconstructing the calculated un-reconstruction image on the display surface 11 as an integrated image 13 through the lens array layer 2 to reproduce a stereo image. Since the angle of view is oblique, the calculated un-reconstruction image will be slightly different. Referring to FIGS. 2 to 4, the three dimensional objects respectively shown in the three figures are the same object, but since the angles of view are different, the image algorithm needs to match the settings of the different displaying angles, resulting in that the calculated un-reconstruction image will be slightly different. With a two-layer structure of the image display device 1 of the present disclosure, lights can be transmitted from the image display device 1 and be re-converged into a stereo image in mid-air through the lens array layer 2 so as to conform to an ergonomic angle of view.

### Third Embodiment

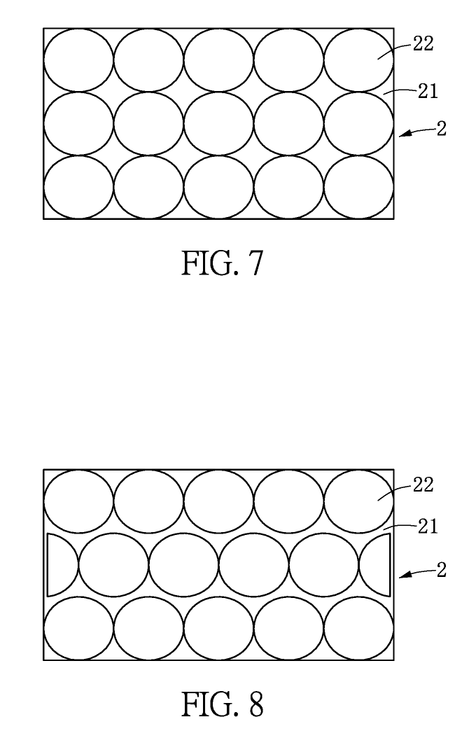

The lens array layer 2 of the present disclosure has a significant correlation to the display effect. Referring to FIG. 7 and FIG. 8, the lens array layers 2 can be arranged in a rectangular arrangement or a hexagonal arrangement, that is, the lenses 22 in each two adjacent columns are arranged in an aligned arrangement (FIG. 7) or a staggered arrangement (FIG. 8). Further, each of the arrangements can be used to produce a stereo image.

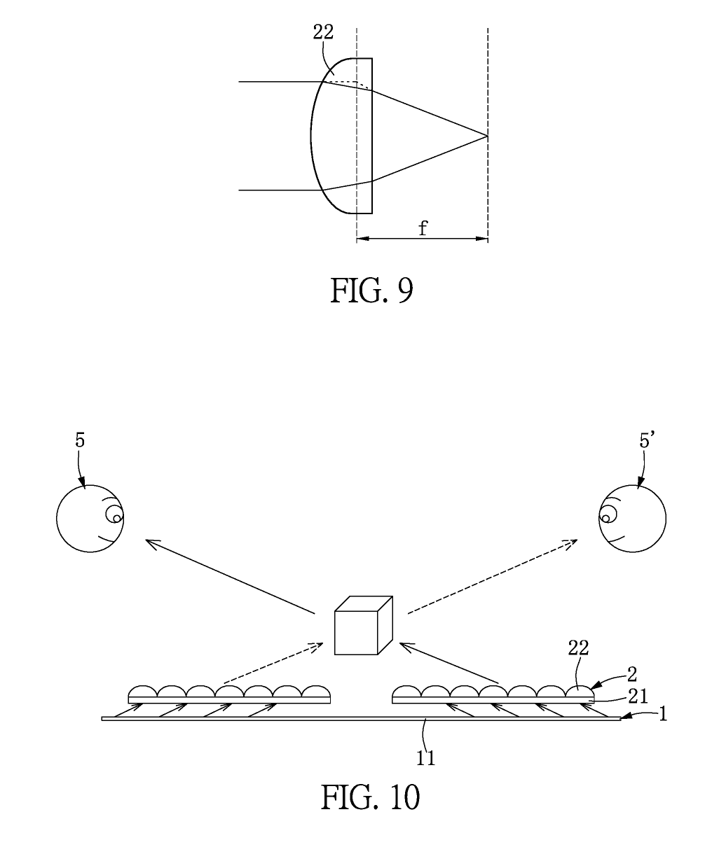

The microstructures on the lens array layer 2 are the lenses 22 having the light focusing function. The light focusing ability of each lens 22 can be determined according to the refractive index (n value) of its material. Each of the lenses 22 transmits light having a wavelength range of 300 nm to 1100 nm. Each of the lenses 22 conforms to Lensmaker's equation (FIG. 9): 1/f=(n−1)(1/R1+1/R2), in which R1 and R2 are the respective radiuses of curvature of bilateral surfaces of the lens 22, f is the focal length of the lens 22, and n is the refractive index of the lens 22. In addition, each of the lenses 22 has a diameter of 100 um to 5 mm, which is adapted to the pixel size of different display devices.

### Fourth Embodiment

Referring to FIG. 10, the present embodiment provides an application of the image display apparatus in an oblique angle of view. At both sides of the image display device 1, users 5, 5′ can see the image data from the opposite side respectively. The image display device 1 can be configured to use a directional backlight module to cooperate with the calculated un-reconstruction image for providing front and back images of the same three dimensional object to the users 5, 5′ at both sides of the image display device 1 respectively, so as to achieve the purpose of multi-angle of views for multiple users. The use of directional backlight module is to provide a specific angle of light, to avoid excessive divergence angle, and to avoid the image interference. The calculated un-reconstruction image needs to pre-calculate the stereo image display area corresponding to the provided angle. This approach can solve the problem of insufficient angle of view of conventional naked-eye image display devices.

### Fifth Embodiment

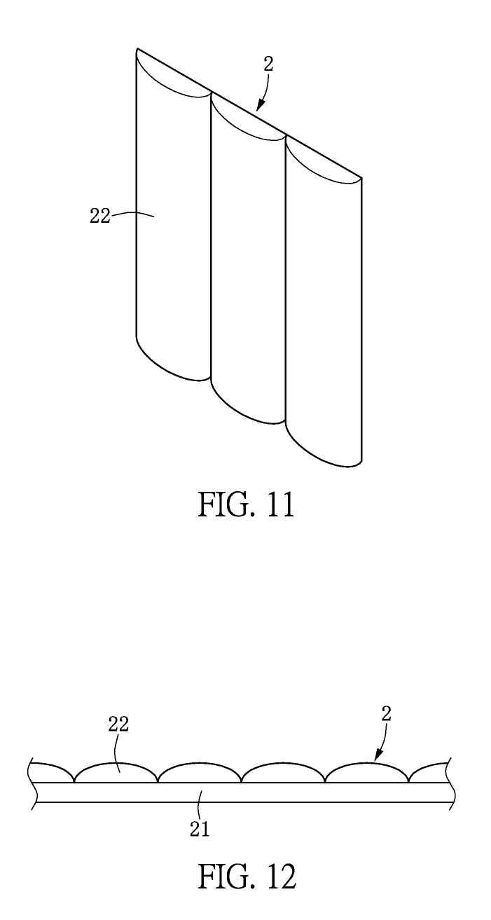

Referring to FIGS. 11 and 12, the lenses 22 of the lens array layer 2 have columnar structures, that is, the lenses 22 are columnar lenses. Accordingly, the lenses 22 have the lens characteristics only in one-dimensional orientation (not in another-dimensional orientation).

### Sixth Embodiment

The image display device 1 of the present disclosure can be a stereoscopic image display device with a human eye tracking function. The image display device 1 according to the present embodiment of the present disclosure can give a user 5 a greater angle of view, and is capable of tracking a position of a user's eye in a screen by a sensing element, calculating an oblique angle of view of the user 5 with respect to the image display device 1 according to the position, and providing a suitable un-reconstruction image relative to the oblique angle of view so as to reproduce the stereo image when the user's eye is moving. Accordingly, it is possible to give the corresponding stereo image according to the movement of the user's position and solve the problem of insufficient angle of view of conventional naked-eye image display devices.

The present disclosure provides an image display apparatus and an image display method thereof which can be applied to an oblique angle of view. The image display apparatus, in conjunction with the hardware arrangement, controls the direction of lights emitted from each pixel in the image display device through the optical element. The hardware system of the present disclosure includes simple optical elements, such as an image display device and a lens array layer, which can be packaged as a kit. Also, the hardware system can be configured to display the realistic stereo image in mid-air by the designed pixel size, system gap, lens size and focal length, and by using the integrated image principle to match the screen output signal calculated by the particular algorithm.

In terms of hardware, the image display apparatus of the present disclosure requires only an image display device and a lens array layer to achieve the floating stereo image without using other optical films, thereby providing a relative simple structure. The image display method of the present disclosure, which is different from the general integrated image calculation algorithms, can be applied to an oblique angle of view, and can provide the calculated image corresponding to a particular angle.

The descriptions illustrated supra set sixth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. An image display apparatus for displaying a stereo image that is floating in mid-air and is observable at an oblique angle of view, comprising:
an image display device including a display surface and an image calculating unit, the image display device being configured to display an un-reconstruction image on the display surface by the image calculating unit;
a lens array layer being disposed on the display surface of the image display device, the lens array layer including a base and a plurality of lenses, the lenses being disposed on a surface of the base, and each of the lenses transmits light having a wavelength range of 300 nm to 1100 nm; wherein the lens array layer is configured to reconstruct the un-reconstruction image on the display surface as an integrated image to reproduce a stereo image.

2. The image display apparatus according to claim 1, wherein the lenses in each two adjacent columns are arranged in an aligned arrangement or a staggered arrangement.

3. The image display apparatus according to claim 1, wherein the lenses are columnar lenses.

4. The image display apparatus according to claim 1, wherein each of the lenses has a diameter of 100 um to 5 mm, and each of the lenses conforms to Lensmaker's equation: 1/f=(n−1)(1/R1+1/R2), wherein R1 and R2 are the respective radiuses of curvature of bilateral surfaces of each of the lenses, f is the focal length of the lens, and n is the refractive index of the lens.

5. The image display apparatus according to claim 1, wherein the image display device is a stereoscopic image display device with a human eye tracking function.

6. An image display method, comprising:
providing an image display apparatus, the image display apparatus including an image display device and a lens array layer, the image display device including a display surface and an image calculating unit, the lens array layer being disposed on the display surface of the image display device, the lens array layer including a base and a plurality of lenses, the lenses being disposed on a surface of the base, and each of the lenses transmits light having a wavelength range of 300 nm to 1100 nm;
executing a coordinate definition step for setting relative positions of hardware, the relative positions of hardware including a relative position of each of the lenses of the lens array layer, a distance between the lens array layer and the image display device, and a pixel size match;
inputting data of a three dimensional object prepared to display to the image calculating unit;
setting a displaying oblique angle of the three dimensional object;
performing a ray tracing operation and displaying an un-reconstruction image on the display surface of the image display device; and
reconstructing the un-reconstruction image on the display surface as an integrated image through the lens array layer to reproduce a stereo image.

7. The image display method according to claim 6, wherein the lenses in each two adjacent columns are arranged in an aligned arrangement or a staggered arrangement.

8. The image display method according to claim 6, wherein each of the lenses has a diameter of 100 um to 5 mm, and each of the lenses conforms to Lensmaker's equation: 1/f=(n−1)(1/R1+1/R2), wherein R1 and R2 are the respective radiuses of curvature of bilateral surfaces of each of the lenses, f is the focal length of the lens, and n is the refractive index of the lens.

9. The image display method according to claim 6, further comprising: using a directional backlight module to cooperate with the un-reconstruction image for providing front and back images of the three dimensional object to the users at both sides of the image display device respectively.

10. The image display method according to claim 6, wherein the image display device is a stereoscopic image display with a human eye tracking function, and is capable of tracking a position of a user's eye in a screen by a sensing element, calculating an oblique angle of view of the user with respect to the image display device according to the position, and providing a suitable un-reconstruction image relative to the oblique angle of view so as to reproduce the stereo image when the user's eye is moving.
